(19) United States
(12) Patent Application Publication
(10) Pub. No.: US 2008/0224792 A1
(43) Pub. Date: Sep. 18, 2008

(54) Methods and apparatuses for suppressing interference

(76) Inventor: Jorgen Staal Nielsen, Calgary (CA)

Correspondence Address: THELEN REID BROWN RAYSMAN & STEINER LLP, P. O. BOX 640640, SAN JOSE, CA, 95164-0640, US

(21) Appl. No.: 11/724,038

(22) Filed: Mar. 13, 2007

(51) Int. Cl. G05B 13/02; H04B 1/10; H04B 3/04

(52) U.S. Cl. 333/17.1; 700/37; 327/556; 375/344; 375/345

(57) ABSTRACT

Embodiments of the invention provide an adaptive notch filter that employs a power detector as a feedback control mechanism to steer the notch filter. One such embodiment of the invention provides adaptive control of the notch filter capacitor to tune the notch filter frequency based upon a diode power detector. One embodiment of the invention provides a system including multiple cascaded adaptive notch filters each having a feedback control method from a power detector to separately control each filter. For one embodiment of the invention a method is disclosed for tuning an adaptive notch filter using a dithering process to determine a minimum power output at the power detector. One embodiment includes an adaptive notch filter implementing a device with a tunable resonance frequency.

### STATEMENT OF GOVERNMENT INTEREST

The invention, of which embodiments are described herein, was made at least in part with support from the Government of Canada. The Canadian Government may have certain rights to the invention.

### FIELD OF THE INVENTION

Embodiments of the invention relate generally to the communications systems and more particularly to methods and apparatuses for suppressing interference in such systems.

### BACKGROUND OF THE INVENTION

Radio communications systems are susceptible to various types of interference from a number of sources. For example, ultra-wideband (UWB) systems (e.g., >500 Mhz or 25% of center frequency) are employed for wireless applications requiring very high data rates. Typically, UWB systems have low power spectral densities (PSDs) and are therefore vulnerable to narrowband interference (NBI) from sources occupying the same band. In particular is the 3.1-10.6 GHz range authorized by the FCC for unlicensed use. The FCC UWB rules limit the PSD emission limit for UWB emitters to −41.3 dBm/Mhz. Due to this restraint on transmission power level, the UWB systems are subject to NBI (i.e., narrowband relative to the UWB) caused by coexisting systems transmitting at much higher power levels. To obtain a practical aggregate transmit power, a large signal bandwidth is typically used in a UWB system. The NBI from various coexisting sources sharing the same band can be of much higher power relative to the desired UWB signal at the receiver. The NBI can be dominant to the point communications based on UWB is precluded. Therefore, NBI suppression is critical to UWB systems. Many methods exist for suppressing interference in wideband radio communications systems and such methods have been developed over many years. Conventional methods of suppressing NBI in broadband communications systems have distinct disadvantages.

One suppression method employs a pre-tuned notch filter set to the center frequency of the NBI. Such a scheme sacrifices a small portion of the UWB signal spectrum, however the large spectral redundancy of typical UWB modulations allows the UWB signal to be effectively recovered despite the loss of some spectral components. Pre-tuned notch filters tuned to coincide with the bands of commonly encountered sources of NBI may be implemented as part of a UWB antenna system or using passive lumped or distributed circuit elements at the output of the antenna. Dual antenna receivers employing spatial filtering to suppress NBI have been implemented where the NBI is strongly specular.

The disadvantage of pre-tuned notch filters is that the design is based on knowledge of where the NBI lies, which is not always practical. Tunable notch filters have been implemented to suppress NBI occurring at arbitrary frequencies within the UWB signal bandwidth. Tunable notch filters have been implemented using varactor diodes or digitally-switched microelectromechanical systems (MEMS) to provide significant relative tuning range within the UWB range. Such schemes can provide a selectable set of notch filter responses (e.g., implementing a switched array of progressively sized capacitors) or a continuous response (e.g., implementing a continuously variable capacitor).

The disadvantage with conventional tunable notch filters is that the notch filter steering is implemented after detection of the signal. This approach requires burdensome signal processing to determine the location of the NBI. That is, the notch filter output signal is extensively processed. That output is used to try to decipher what the signal interference is, and then the notch filter is steered accordingly. The process of sampling and processing the UWB signal to determine the spectrum of the signal and the NBI is not only complicated and costly in terms of processing resources, but also results in significant delay (e.g., milliseconds).

Other prior art schemes for NBI suppression involve sampling the signal at a high rate and high quantization level and then employing digital signal processing methods to suppress the NBI. Some such conventional NBI suppression techniques rely on the processing gain from the large compression available in spread spectrum UWB signals.

Generalized matched filtering methods are possible to effect NBI suppression, but the multibit sampling and extensive processing of the received signal limits the practicality of post-detection processing. Additionally, the reduced complexity of typical UWB receivers that are based on differential or reference pulse processing are particularly sensitive to NBI due to the excess squaring loss of the differential multiplication and post-detection processing is not effective in addressing the effects of NBI.

### BRIEF DESCRIPTION OF THE DRAWINGS

The invention may be best understood by referring to the following description and accompanying drawings that are used to illustrate embodiments of the invention. In the drawings:

FIG. 1 illustrates an adaptive notch filter in accordance with one embodiment of the invention;

FIG. 2 illustrates a diode power detector that may be used to determine the output power of an adaptive notch filter in accordance with one embodiment of the invention;

FIG. 3 illustrates an adaptive notch filter implementing a tunable MEMS capacitor in accordance with one embodiment of the invention;

FIG. 4 illustrates the frequency response of the adaptive notch filter of FIG. 3 in accordance with one embodiment of the invention;

FIG. 5 illustrates a UWB receiver system implementing multiple cascaded adaptive notch filters in accordance with one embodiment of the invention;

FIG. 6 illustrates a process for tuning a notch filter that may be used to effect NBI suppression in accordance with one embodiment of the invention; and

FIG. 7 illustrates a functional block diagram of a digital processing system in accordance with one embodiment of the invention.

### DETAILED DESCRIPTION

Embodiments of the invention provide an adaptive notch filter that employs a power detector as a feedback control mechanism to steer the notch filter. One such embodiment of the invention provides adaptive control of the notch filter capacitor to tune the notch filter frequency based upon a diode power detector. One embodiment of the invention provides a system including multiple cascaded adaptive notch filters each having a feedback control method from a power detector to separately control each filter. For one embodiment of the invention a method is disclosed for tuning an adaptive notch filter using a dithering process to determine a minimum power output at the power detector.

In the following description, numerous specific details are set forth. However, it is understood that embodiments of the invention may be practiced without these specific details. In other instances, well-known circuits, structures and techniques have not been shown in detail in order not to obscure the understanding of this description.

Reference throughout the specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout the specification are not necessarily all referring to the same embodiment. Furthermore, the particular features, structures, or characteristics may be combined in any suitable manner in one or more embodiments.

Moreover, inventive aspects lie in less than all features of a single disclosed embodiment. Thus, the claims following the Detailed Description are hereby expressly incorporated into this Detailed Description, with each claim standing on its own as a separate embodiment of this invention.

### Adaptive Notch Filter

Embodiments of the invention are applicable to a wide range of communications systems in which NBI is problematic. For example, embodiments of the invention are applicable to systems having a low (e.g., approximately 0 dB or less) input signal-to-noise ratio (i.e., input signal to wideband noise) with NBI present. Such systems include, but are not limited to UWB systems including UWB systems with operational frequencies of 3.1 GHz-10.6 GHz.

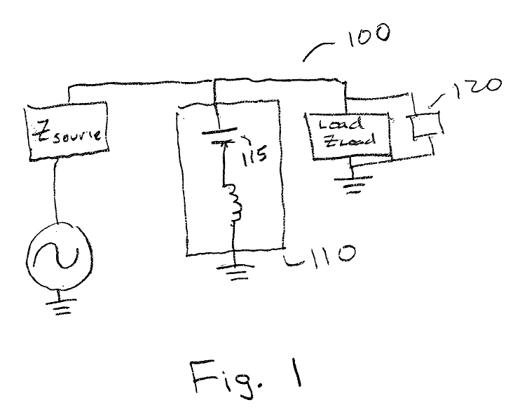

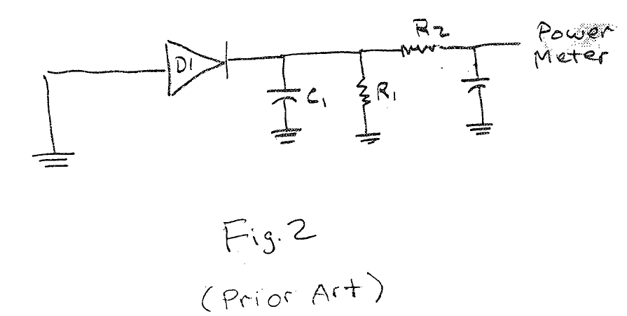

FIG. 1 illustrates an adaptive notch filter in accordance with one embodiment of the invention. Adaptive notch filter 100, shown in FIG. 1 includes a shunt LC circuit 110 that includes a variable capacitor 115. In accordance with one embodiment of the invention, the adaptive notch filter 100 includes an output power detector 120 that may be implemented as a diode power detector as illustrated in FIG. 2.

As can be discerned from FIG. 1, extant NBI will represent a dominant portion of the signal power detected at power detector 120 within the bandwidth of the UWB signal. Thus, the adaptive notch filter 100 can be effectively steered by adjusting the notch filter frequency so as to reduce the total broadband power at the output of the adaptive notch filter 100 as measured by power detector 120. If the broadband output power is minimized, the notch filter is tuned to an effective frequency for suppressing the NBI.

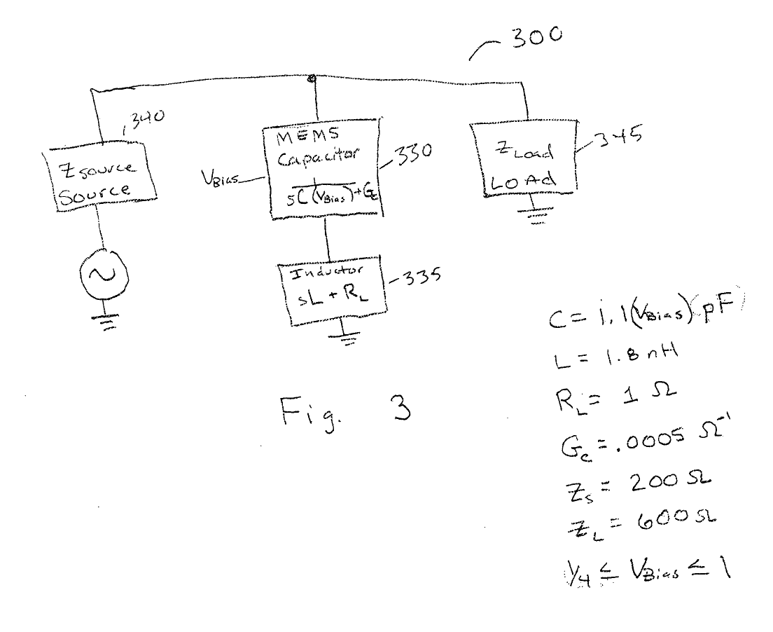

FIG. 3 illustrates an adaptive notch filter implementing a tunable MEMS capacitor in accordance with one embodiment of the invention. As shown in FIG. 3, adaptive notch filter 300 implements a tunable MEMS capacitor 330 for the variable capacitor 115 shown in FIG. 1. The tunable MEMS capacitor is an electostatically tunable parallel plate capacitor as known in the art. With conventional tunable MEMS capacitors, the distance between the two parallel plates can be adjusted by adjusting the applied voltage. The distance between the plates can be tuned by a spring attached to one of the plates. For a given voltage difference between the plates, the distance of the two plates can be computed based on the characteristics of the spring.

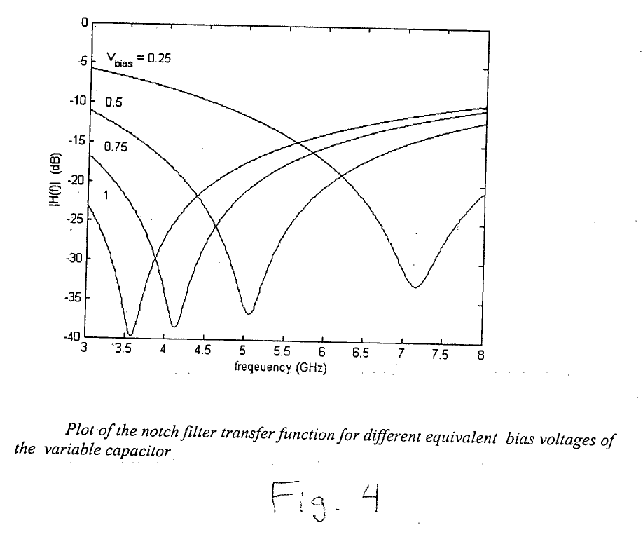

FIG. 4 illustrates the frequency response of the adaptive notch filter of FIG. 3 in accordance with one embodiment of the invention. The Q values of the capacitor 330 and the inductor 335 are less than 100 over the frequency range of the UWB signal enabling a monolithic MEMS realization. Capacitor 330 has an adjustable value based on the bias voltage with C=1.1 (V_{bias}) pF and G_{c}=0.0005 mhos; inductor 335 has a value 1.8 nH with R_{L}=1 ohm; the source impedance 340 has a value of 200 ohms; and the load impedance 345 has a value of 600 ohms

As can be discerned from FIG. 4, the finite Q of the capacitor 330 and the inductor 335 as well as the source impedance 340 and the load impedance 345 limit the depth of the notch. For alternative embodiments of the invention, a deeper narrower notch can be achieved by implementing an adaptive notch filter higher Q value components or with a more complex structure. For example, for one embodiment of the invention includes an adaptive notch filter implementing two parallel LC resonators in addition to the shunt LC resonator 115 of FIG. 1.

### Cascaded Adaptive Notch Filters

As discussed above, implementation of an adaptive notch filter in accordance with an embodiment of the invention may be to effect suppression of NBI. As evident from the frequency response curves of FIG. 4, the relative suppression of NBI effected by a single adaptive notch filter may not be sufficient to achieve adequate NBI suppression.

In accordance with one embodiment of the invention, multiple adaptive notch filters are cascaded in order to increase NBI suppression.

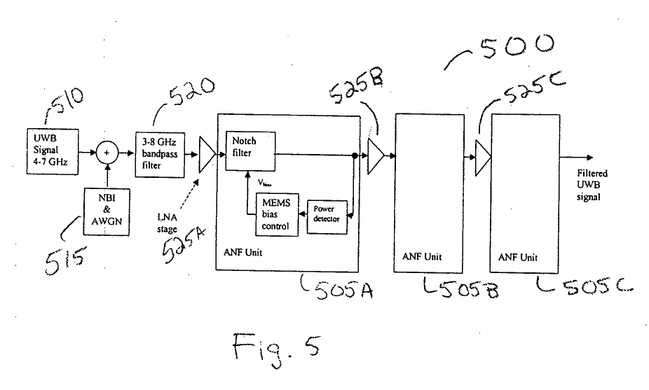

FIG. 5 illustrates a UWB receiver system implementing multiple cascaded adaptive notch filters in accordance with one embodiment of the invention. System 500, shown in FIG. 5 includes multiple cascaded adaptive notch filters, shown for example as adaptive notch filters 505A-505C. As shown in FIG. 5 a UWB signal 510 is received at the antenna of the receiver system. Interference in the form of NBI and wideband interference, shown as NBI & additive white Gaussian noise (AWGN) 515 is also received. The received signal is input to a band pass filter 520 to filter out of band frequency components prior to being input to the multiple cascaded adaptive notch filters 505A-505C. The tuning of each adaptive notch filter performed separately. For one embodiment of the invention control coordination of the tuning of each adaptive notch filter is implemented to ensure smooth overall convergence.

As shown in FIG. 5, a low noise amplifier (LNA) (shown for example, as LNAs 525A-525C) is implemented for each adaptive notch filter block to isolate the successive cascaded notch filters and to reduce the degradation in the overall receiver noise figure.

### Notch Filter Tuning

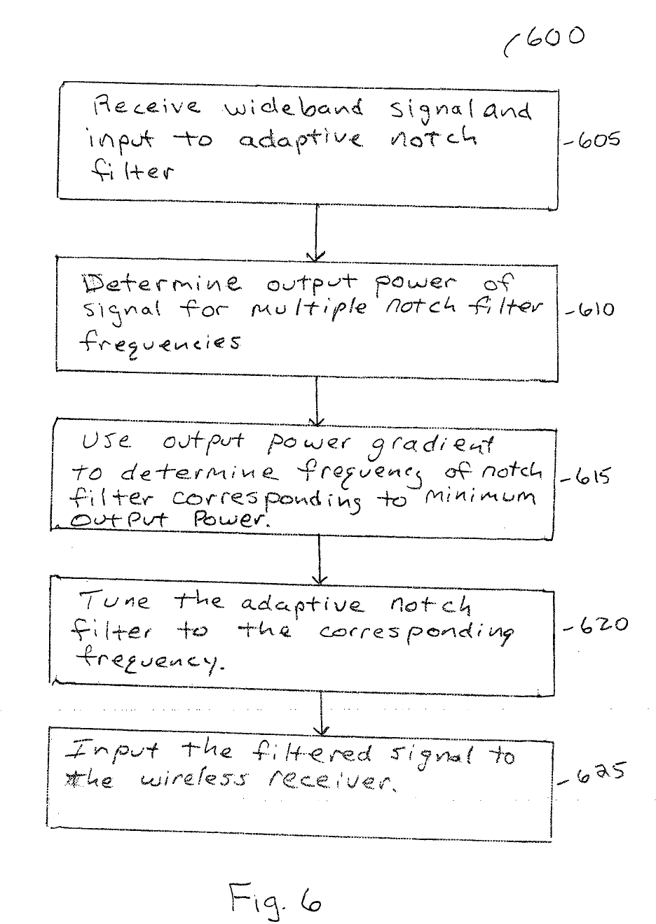

FIG. 6 illustrates a process for tuning a notch filter that may be used to effect NBI suppression in accordance with one embodiment of the invention. Process 600, shown in FIG. 6, begins at operation 605 in which a wideband signal is received via the antenna of a wireless receiver. The wideband signal is subject to NBI and has a low PSD relative to the NBI.

At operation 610 the wideband signal is input to an adaptive notch filter and the output power of the adaptive notch filter is determined for multiple operational frequencies of the adaptive notch filter.

At operation 615 the gradient of the output power is used to determine a minimum output power. The minimum output power corresponding to a frequency of the adaptive notch filter. The adaptive notch filter is tuned toward the minimum output power. Initially the notch filter is set to a certain frequency. The output power of the power detector is measured. The adaptive notch filter frequency is adjusted in one direction (e.g., slightly higher or lower) and the output of the power detector is remeasured. If the output power has decreased, the adaptive notch filter frequency is adjusted in same direction; if the output power has increased, the adaptive notch filter frequency is adjusted in the other direction.

For one embodiment of the invention a dithering loop is implemented that adjusts the adaptive notch filter frequency back and forth over a very small range.

At operation 620 the adaptive notch filter is tuned to the frequency corresponding to the minimum output power. In accordance with the teachings of embodiments of the invention, when the notch filter is tuned to the frequency of the NBI, the minimum output power of the notch filter is obtained.

At operation 625 the output signal from the tuned notch filter is input to the wireless receiver.

Included as Appendix A is an exemplary algorithm for effecting tuning of an adaptive notch filter for systems implementing one or more adaptive notch filters in accordance with various embodiments of the invention.

### General Matters

Embodiments of the invention include adaptive notch filters implementing a shunt LC circuit and output power detector. For one embodiment of the invention, the shunt LC circuit may implement a MEMS variable capacitor. For an alternative embodiment the MEMS variable capacitor can be replaced with a varactor. In general, for various alternative embodiments the shunt LC circuit may be replaced with any device with a tunable resonance frequency. For one embodiment of the invention the output power detector may be implemented as a diode power detector. For an alternative embodiment the output power detector may be implemented using a thermistor.

Embodiments of the invention therefore avoid the extensive digital signal processing involved in prior art schemes. Embodiments of the invention implement a low cost power detector and an algorithm to determine the minimum output power of the adaptive notch filter. The adaptive notch filter is then tuned to the frequency corresponding to the minimum output power to effect NBI suppression.

Embodiments of the invention have been described above as implementing a dithering algorithm to determine the gradient of the output power of the power detector. It will be apparent to those skilled in the art that various alternative embodiments may implement other methods of determining the gradient of the output power of the power detector. For example, the gradient may be determined by operating multiple notch filters concurrently where the notch filters are tuned to successive operational frequencies. Then comparing the output power of each notch filter can provide the gradient of the output power of the power detector.

Further, although embodiments of the invention describe determining the gradient of the output power detector to tune the adaptive notch filter, alternative embodiments of the invention use a digitized sampling of the adaptive notch filter output power to tune the adaptive notch filter. For example, by sampling the output power, an estimated minimum output power and corresponding adaptive notch filter frequency can be determined without the excessive processing to estimate the interference spectrum as required in prior art schemes. In general, embodiments of the invention determine the output power of the adaptive notch filter at varying frequencies and tune the adaptive notch filter based upon this determination.

Embodiments of the invention have been described as including various operations. Many of the processes are described in their most basic form, but operations can be added to or deleted from any of the processes without departing from the scope of the invention.

The operations of the invention may be performed by hardware components or may be embodied in machine-executable instructions, which may be used to cause a general-purpose or special-purpose processor or logic circuits programmed with the instructions to perform the operations. Alternatively, the steps may be performed by a combination of hardware and software. The invention may be provided as a computer program product that may include a machine-readable medium having stored thereon instructions, which may be used to program a computer (or other electronic devices) to perform a process according to the invention. The machine-readable medium may include, but is not limited to, floppy diskettes, optical disks, CD-ROMs, and magneto-optical disks, ROMs, RAMs, EPROMs, EEPROMs, magnet or optical cards, flash memory, or other type of media / machine-readable medium suitable for storing electronic instructions. Moreover, the invention may also be downloaded as a computer program product, wherein the program may be transferred from a remote computer to a requesting computer by way of data signals embodied in a carrier wave or other propagation medium via a communication cell (e.g., a modem or network connection).

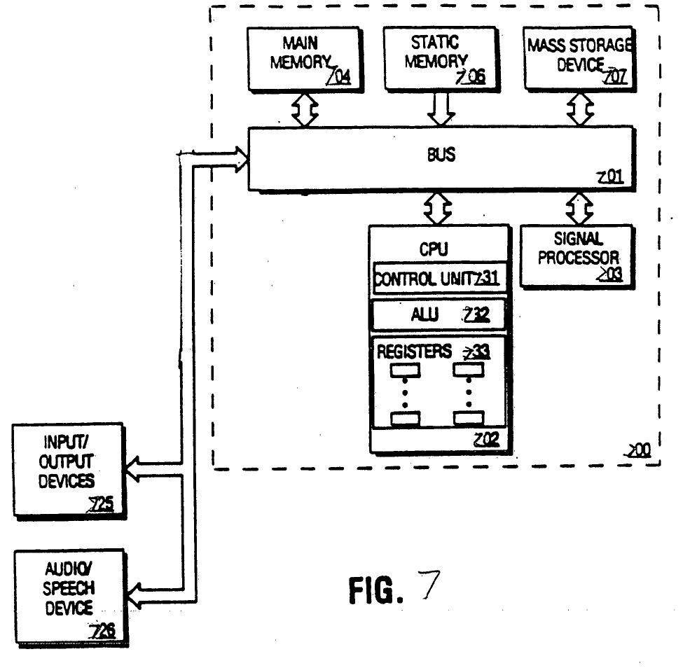

As discussed above, embodiments of the invention may employ DSPs or devices having digital processing capabilities. FIG. 7 illustrates a functional block diagram of a digital processing system in accordance with one embodiment of the invention. The components of processing system 700, shown in FIG. 7 are exemplary in which one or more components may be omitted or added. For example, one or more memory devices may be utilized for processing system 700.

Referring to FIG. 7, processing system 700 includes a central processing unit 702 and a signal processor 703 coupled to a main memory 704, static memory 706, and mass storage device 707 via bus 701. In accordance with an embodiment of the invention, main memory 704 may store a selective communication application, while mass storage device 707 may store various digital content as discussed above. Processing system 700 may also be coupled to input/output (I/O) devices 725, and audio/speech device 726 via bus 701. Bus 701 is a standard system bus for communicating information and signals. CPU 702 and signal processor 703 are processing units for processing system 700. CPU 702 or signal processor 703 or both may be used to process information and/or signals for processing system 700. CPU 702 includes a control unit 731, an arithmetic logic unit (ALU) 732, and several registers 733, which are used to process information and signals. Signal processor 703 may also include similar components as CPU 702.

Main memory 704 may be, e.g., a random access memory (RAM) or some other dynamic storage device, for storing information or instructions (program code), which are used by CPU 702 or signal processor 703. Main memory 704 may store temporary variables or other intermediate information during execution of instructions by CPU 702 or signal processor 703. Static memory 706, may be, e.g., a read only memory (ROM) and/or other static storage devices, for storing information or instructions, which may also be used by CPU 702 or signal processor 703. Mass storage device 707 may be, e.g., a hard or floppy disk drive or optical disk drive, for storing information or instructions for processing system 700.

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

What is claimed is:

1. An apparatus comprising:
a tunable notch filter to receive a wideband signal having narrowband interference; and
a power detector coupled to the notch filter to determine the output power of the notch filter.

2. The apparatus of claim 1 wherein the tunable notch filter implements a device having a tunable resonance frequency.

3. The apparatus of claim 2 wherein the device having a tunable resonance frequency is selected from the group consisting of a shunt LC circuit, a MEMS variable capacitor, and a varactor.

4. The apparatus of claim 1 wherein the power detector is implemented as a diode power detector.

5. The apparatus of claim 1 wherein the power detector is implemented as a thermistor.

6. The apparatus of claim 1 further comprising:
one or more additional tunable notch filters implemented in cascade with the tunable notch filter.

7. The apparatus of claim 6 wherein a low noise amplifier is implemented for each of the cascaded tunable notch filters.

8. The apparatus of claim 7 wherein each of the tunable notch filters is tuned independently and control coordination of the tuning of each tunable notch filter is implemented.

9. A method comprising:
receiving a wideband signal to an adaptive notch filter;
determining the output power of the adaptive notch filter; and
tuning the adaptive notch filter based upon the output power.

10. The method of claim 9 wherein the wideband signal is an ultra wideband signal in a frequency range of 3.1 GHz-10.6 GHz.

11. The method of claim 10 wherein determining the output power of the adaptive notch filter includes determining an output power value corresponding to each of multiple operational frequencies of the adaptive notch filter and determining an output power gradient using the determined output power values.

12. The method of claim 11 wherein tuning the adaptive notch filter includes using the output power gradient to determine an adaptive notch filter frequency corresponding to a minimum output power and tuning the adaptive notch filter to the corresponding frequency.

13. The method of claim 12 wherein the output power gradient is determined using a dithering algorithm.

14. The method of claim 12 wherein the output power gradient is determined by operating multiple notch filters concurrently, each notch filter tuned to a successive operational frequency.

15. The method of claim 10 wherein the output power of the adaptive notch filter is determined by sampling the output power.

16. The method of claim 15 wherein tuning the adaptive notch filter based upon the output power is effected by estimating a minimum output power and corresponding adaptive notch filter frequency.

17. A machine-readable medium that provides executable instructions, which when executed by a processor, cause the processor to perform a method, the method comprising:
receiving a wideband signal to an adaptive notch filter;
determining the output power of the adaptive notch filter; and
tuning the adaptive notch filter based upon the output power.

18. The machine-readable medium of claim 17 wherein the wideband signal is an ultra wideband signal in a frequency range of 3.1 GHz-10.6 GHz.

19. The machine-readable medium of claim 18 wherein determining the output power of the adaptive notch filter includes determining an output power value corresponding to each of multiple operational frequencies of the adaptive notch filter and determining an output power gradient using the determined output power values.

20. The machine-readable medium of claim 19 wherein tuning the adaptive notch filter includes using the output power gradient to determine an adaptive notch filter frequency corresponding to a minimum output power and tuning the adaptive notch filter to the corresponding frequency.

21. The machine-readable medium of claim 20 wherein the output power gradient is determined using a dithering algorithm.

22. The machine-readable medium of claim 20 wherein the output power gradient is determined by operating multiple notch filters concurrently, each notch filter tuned to a successive operational frequency.

23. The machine-readable medium of claim 18 wherein the output power of the adaptive notch filter is determined by sampling the output power.

24. The machine-readable medium of claim 23 wherein tuning the adaptive notch filter based upon the output power is effected by estimating a minimum output power and corresponding adaptive notch filter frequency.
